(19) United States
(12) Patent Application Publication
(10) Pub. No.: US 2014/0132371 A1
(43) Pub. Date: May 15, 2014

(54) NOISE SUPPRESSION DEVICE AND MULTILAYER PRINTED CIRCUIT BOARD CARRYING SAME

(71) Applicant: Eiji Hankui, Tokyo (JP)

(72) Inventor: Eiji Hankui, Tokyo (JP)

(73) Assignee: NEC CORPORATION, Tokyo (JP)

(21) Appl. No.: 14/126,720

(22) PCT Filed: Jun. 21, 2012
(86) PCT No.: PCT/JP2012/066459

§ 371 Date: Dec. 16, 2013

(30) Foreign Application Priority Data
Jun. 22, 2011 (JP) 2011-138668

(51) Int. Cl. H01P 1/20

(52) U.S. Cl. CPC H01P 1/20
USPC 333/202

(57) ABSTRACT

A noise suppression device includes a resonator unit having a plurality of basic resonators each of which is comprised of a resonance pattern with a prescribed resonance length, and a short-circuit pattern for connecting one end of said resonance pattern to a linear pattern, said resonator unit including a basic resonator having a resonance pattern provided on either an upper position and/or lower position relative to the linear pattern and another basic resonator having another resonance pattern provided on either a left position and/or right position relative to the linear pattern.

### TECHNICAL FIELD

The invention relates to a noise suppression device for suppressing a noise current which flows between electronic circuits, and a multilayer printed circuit board mounting it.

### BACKGROUND ART

A portable information terminal, like a mobile phone, and a radio device, like a home computer with a radio unit are widely spreading for convenience and a request for thinning and miniaturization of a device is rising. In order to achieve miniaturization of the radio device, it becomes necessary to densely mount mounting components, like, electronic circuits and electronic components.

A noise which occurs in the mounting components, like a LSI, may enter the other mounting components or electronic circuits and affect them. In particular, electromagnetic interference due to the noise becomes prominent when a signal frequency is high, like the radio device. Some measures thereagainst are therefore required.

Responding to the request, Tokukai 2002-314491 discloses the current control mechanical unit which is configured so that a current path targeted for control is enclosed by a metal face. The current control mechanical unit suppresses entry of a harmonic noise current which occurs in a digital circuit unit into a radio circuit unit side, and suppresses entry of a noise current which occurs in the radio circuit unit into the digital circuit unit.

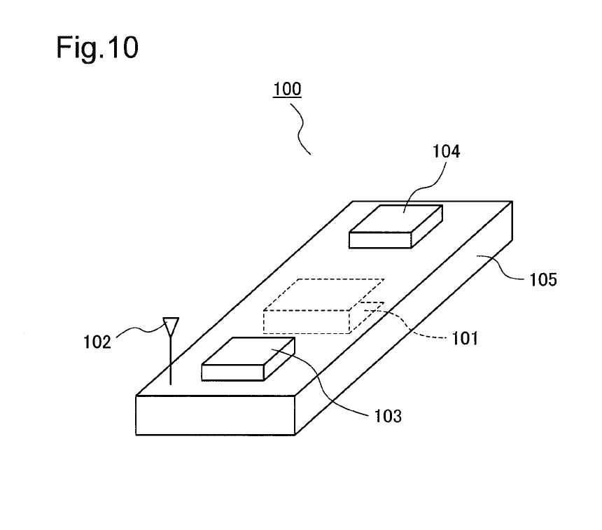

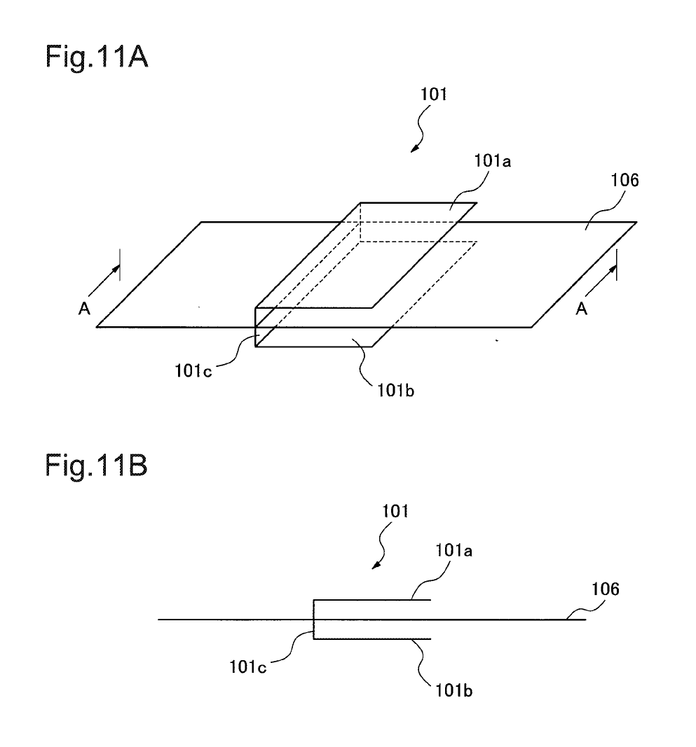

FIG. 10 is a perspective view illustrating a basic configuration example of a portable terminal 100 in the above configuration. FIG. 11A is a perspective view of a noise suppression device 101 used in the portable terminal 100, and FIG. 11B is a cross-sectional view along the line A-A in FIG. 11A.

The portable terminal 100 includes an antenna 102 which transmits and receives a radio wave in order to communicate with a base station, a radio circuit 103 for processing a signal to be transmitted from the antenna 102 and a signal received through the antenna 102, and a printed circuit board 105 mounting a digital circuit 104 performing a predetermined data processing on the received signal.

A ground line 106 shown in FIG. 11 A, a signal line (not shown) connecting the digital circuit 104 to the radio circuit 103, or the like, are arranged in a substrate of the printed circuit board 105.

Since the radio circuit 103 and the digital circuit 104 are densely mounted on the printed circuit board 105 of the portable terminal 100 in a mixed manner, for example, an electromagnetic noise which occurs in the digital circuit 104 enters the radio circuit 103 through the antenna 102 and the ground line 106, and causes electromagnetic interference.

A high-frequency noise occurs since a clock signal with a basic wave of several dozen MHz or several hundred MHz, and a data bus signal are used in the digital circuit 104. If a noise corresponding to a reception band (800 MHz band, 2 GHz, or the like) in the high-frequency noises enters the radio circuit 103 or the antenna 102, radio characteristics, like antenna reception sensitivity, are degraded.

When the noise enters the digital circuit 104 from the antenna 102, mixing between a transmission wave signal and a digital signal occurs and causes electromagnetic interference.

The noise suppression device 101 is therefore configures in the substrate of the printed circuit board 105. The noise suppression device 101 includes metal plates 101a and 101b arranged above and below the ground line 106, respectively. One end part of each of the metal plates 101a and 101b connects to the ground line 106 through a short-circuit plate 101c. The other end parts of the metal plates 101a and 101b (the end parts on the side opposite to the short-circuit plate 101c) are open ends. A resonance length L of each of the metal plates 101a and 101b is set to L=λ/4, wherein λ is a wave length of a noise to be suppressed.

Since input impedance of the open end includes a high value, a noise current which flows from the open end side to the short-circuit plate 101c side is reduced and the noise current becomes hard to pass through the open end. Thereby, interference due to the noise current is suppressed.

### SUMMARY OF THE INVENTION

### Problem to be Solved by the Invention

When a frequency of the noise current is high, the noise current flows close to a surface of a conductor under the influence of a length of penetration. When flowing on the ground line of Tokukai 2002-314491, the above noise current flows on the top surface, the bottom surface, and the surface along the thickness direction. Since the ground line is a conductor in which the width size is larger than the thickness size, the noise current mainly flows on the top surface and the bottom surface. Therefore, to arrange the metal plate along the top surface and the bottom surface of the ground line generates a large noise current suppression effect.

The noise current may flow on a linear pattern like a signal line or a control line. The width size of the linear pattern is not sufficiently large compared with the thickness size thereof. In the configuration of Tokukai 2002-314491, with respect to the noise current flowing in the linear pattern, a sufficient noise current suppression effect is not acquired.

Though a configuration wherein the linear pattern is completely shielded, like a coaxial cable, is possible in principle, it is hard to arrange such configuration in the substrate of the printed circuit board.

A main object of the invention is to provide a noise suppression device and a multilayer printed circuit board mounting the same which can effectively suppress a noise current flowing on a linear pattern configured in a substrate of a printed circuit board.

### Means for Solving the Problem

In order to solve the above problem, the noise suppression device is characterized in including a resonator unit having a plurality of basic resonators each of which is comprised of a resonance pattern with a prescribed resonance length and a short-circuit pattern for connecting one end of the resonance pattern to the linear pattern, wherein the resonator unit includes the basic resonator having the resonance pattern provided on either one or both of an upper position and a lower position relative to the linear pattern and the basic resonator having the resonance pattern provided on either one or both of a left position and a right position relative to the linear pattern.

The multilayer printed circuit board is characterized in including a linear pattern that is configured in at least one interlayer and the noise suppression device, wherein the noise suppression device includes the resonator unit having the plurality of basic resonators each of which is comprised of the resonance pattern with a prescribed resonance length and the short-circuit pattern for connecting one end of the resonance pattern to the linear pattern, wherein the resonator unit includes the basic resonator having the resonance pattern provided on either one or both of an upper position and a lower position relative to the linear pattern and the basic resonator having the resonance pattern provided on either one or both of a left position and a right position relative to the linear pattern.

### Effect of the Invention

In the invention, since the resonance pattern encloses the left, right, upper, and lower sides of the linear pattern targeted for noise suppression, the noise current flowing on the linear pattern configured in the substrate of the printed circuit board can be effectively suppressed.

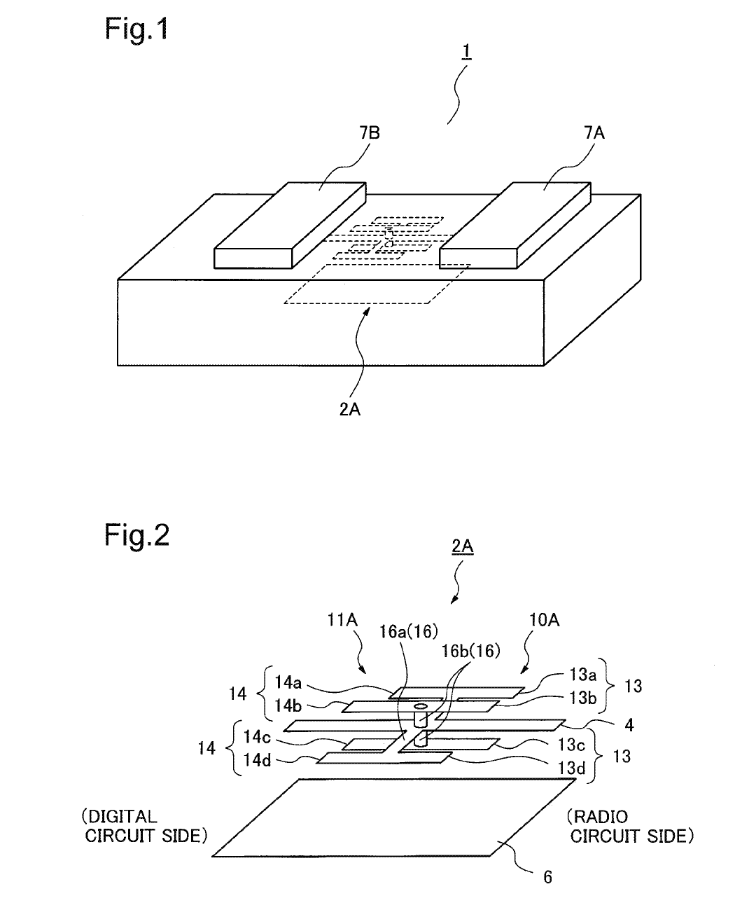

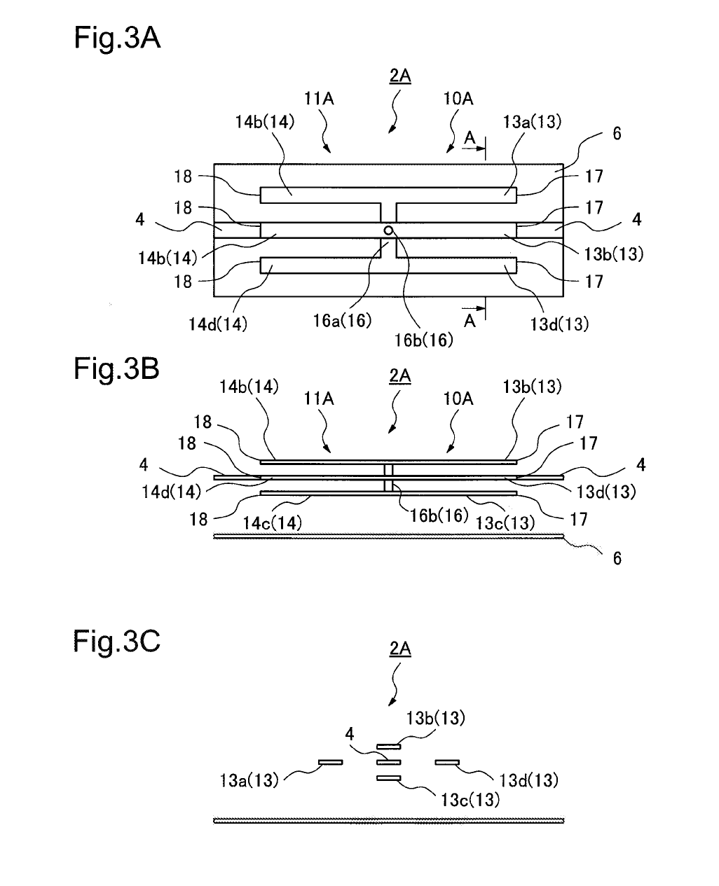

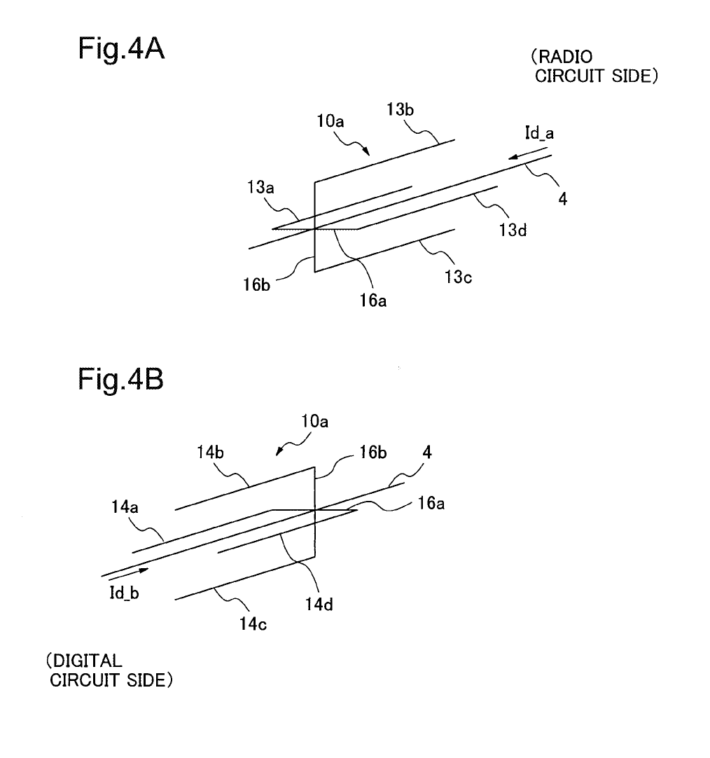

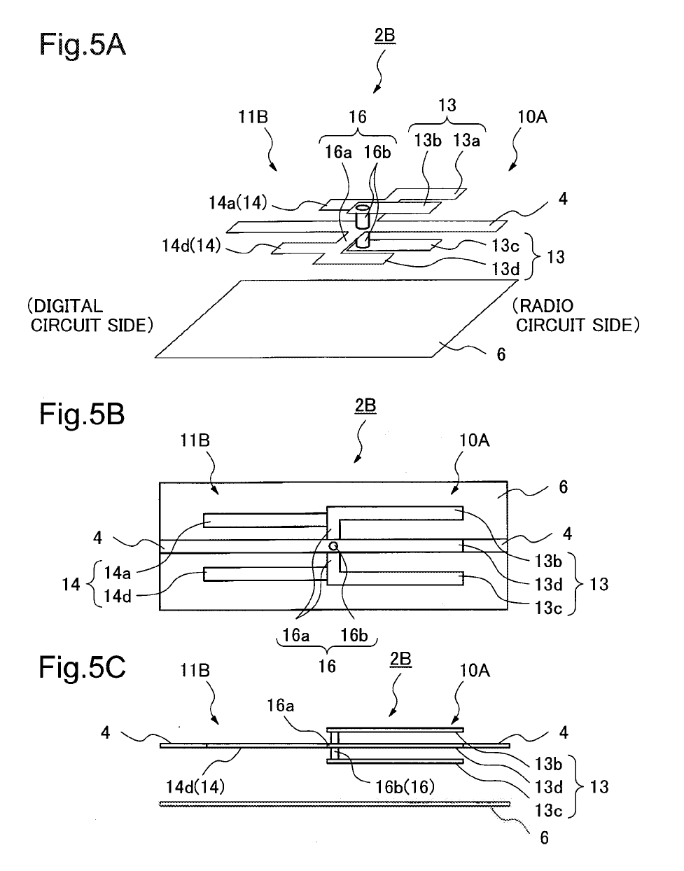

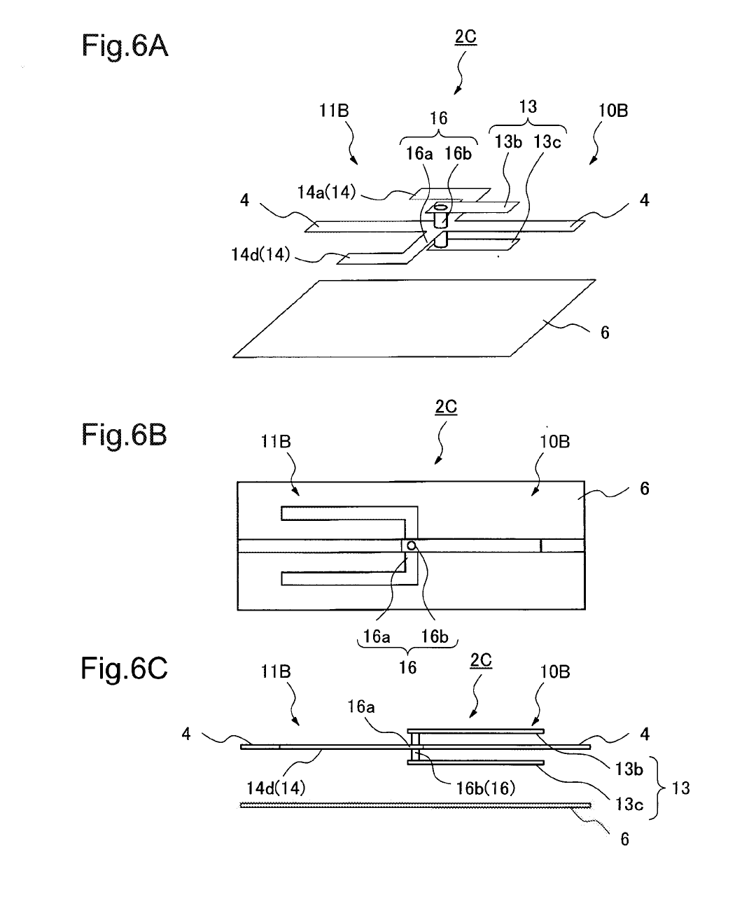

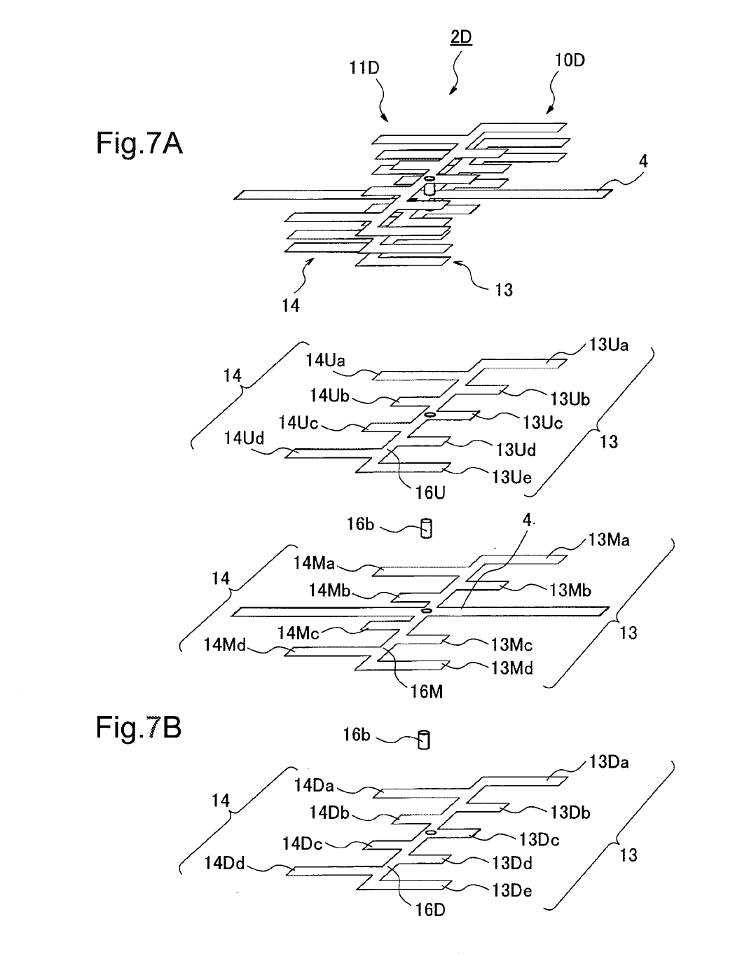

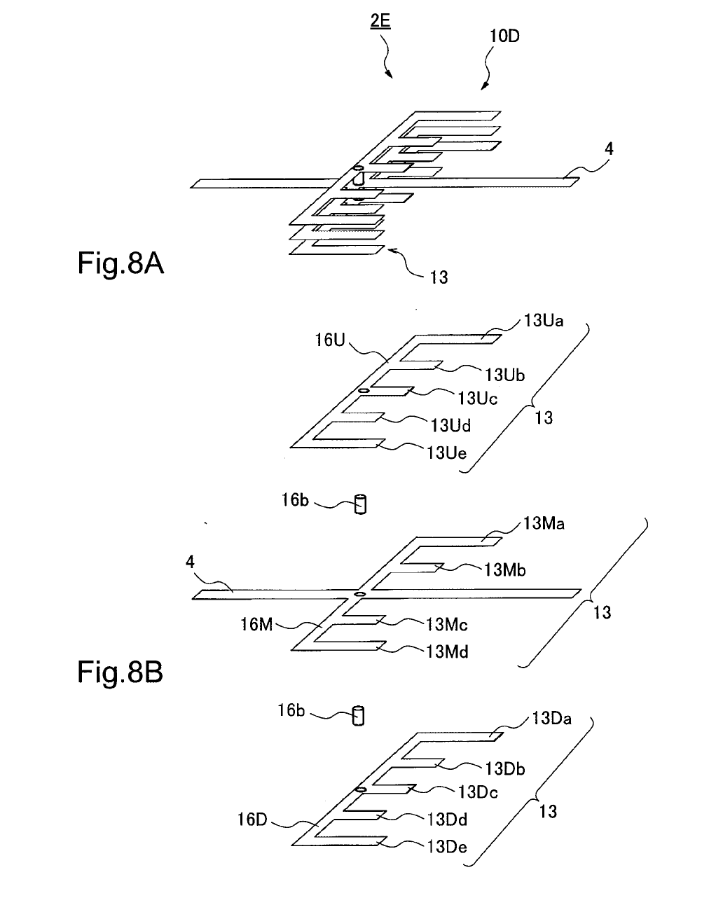

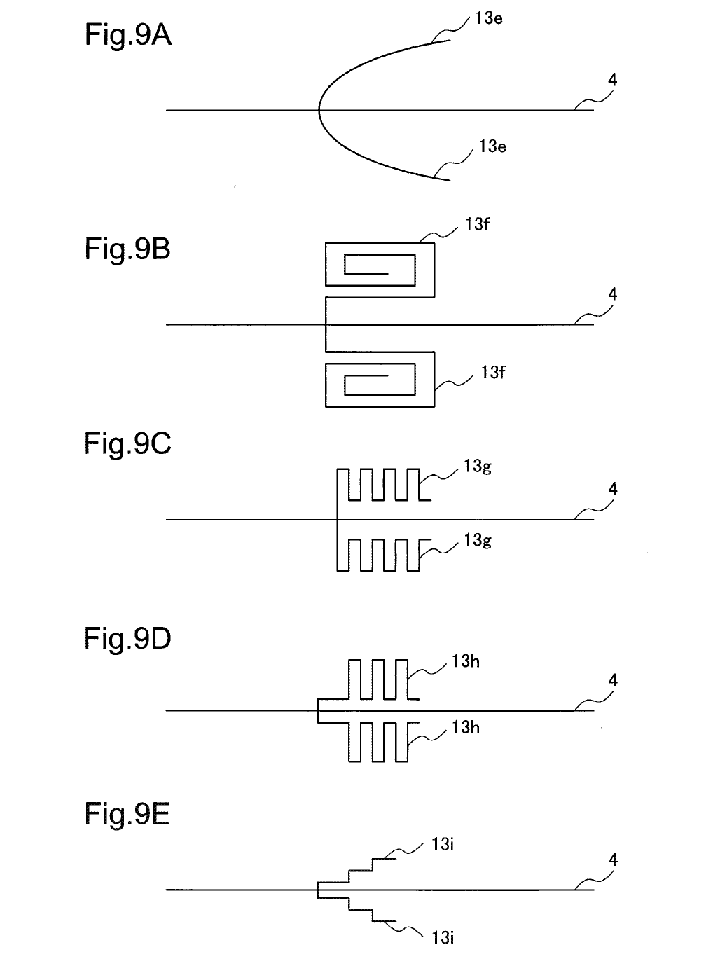

### BRIEF EXPLANATION ON THE DRAWINGS

[FIG. 1] a perspective view of a multilayer printed circuit board including a noise suppression device of a first exemplary embodiment of the invention,

[FIG. 2] a perspective view of the noise suppression device of the first exemplary embodiment,

[FIG. 3A] a top view illustrating a configuration of the noise suppression device of the first exemplary embodiment,

[FIG. 3B] a lateral view illustrating a configuration of the noise suppression device of the first exemplary embodiment,

[FIG. 3C] a cross-sectional view along the line A-A in FIG. 3A illustrating a configuration of the noise suppression device of the first exemplary embodiment,

[FIG. 4A] a diagram illustrating an equivalent model of the first resonator unit in the noise suppression device of the first exemplary embodiment,

[FIG. 4B] a diagram illustrating an equivalent model of a second resonator unit in the noise suppression device of the first exemplary embodiment,

[FIG. 5A] a perspective view illustrating a configuration of a noise suppression device of the second exemplary embodiment of the invention,

[FIG. 5B] a top view illustrating a configuration of the noise suppression device of the second exemplary embodiment of the invention,

[FIG. 5C] a lateral view illustrating a configuration of the noise suppression device of the second exemplary embodiment of the invention,

[FIG. 6A] a perspective view illustrating another configuration of the noise suppression device of the second exemplary embodiment,

[FIG. 6B] a top view illustrating another configuration of the noise suppression device of the second exemplary embodiment,

[FIG. 6C] a lateral view illustrating another configuration of the noise suppression device of the second exemplary embodiment,

[FIG. 7A] a perspective view illustrating a configuration of a noise suppression device of a third exemplary embodiment of the invention,

[FIG. 7B] an exploded perspective view illustrating a configuration of the noise suppression device of the third exemplary embodiment of the invention,

[FIG. 8A] a perspective view illustrating another configuration of the noise suppression device of the third exemplary embodiment,

[FIG. 8B] an exploded perspective view illustrating another configuration of the noise suppression device of the third exemplary embodiment,

[FIG. 9A] a diagram illustrating a resonance pattern with a curve shape of a noise suppression device of a fourth exemplary embodiment of the invention,

[FIG. 9B] a diagram illustrating a resonance pattern with a spiral shape of the noise suppression device of the fourth exemplary embodiment of the invention,

[FIG. 9C] a diagram illustrating a resonance pattern with a switchback shape of the noise suppression device of the fourth exemplary embodiment of the invention,

[FIG. 9D] a diagram illustrating a resonance pattern with another switchback shape of the noise suppression device of the fourth exemplary embodiment of the invention,

[FIG. 9E] a diagram illustrating a resonance pattern with a steps shape of the noise suppression device of the fourth exemplary embodiment of the invention,

[FIG. 10] a perspective view illustrating an example of a basic configuration of a portable terminal applied to an explanation of a related art,

[FIG. 11A] a perspective view illustrating a configuration of a noise suppression device applied to an explanation of a related art,

[FIG. 11B] a cross-sectional view along the line A-A in FIG. 11 illustrating a configuration of the noise suppression device applied to an explanation of a related art.

### MODE FOR CARRYING OUT THE INVENTION

### First Exemplary Embodiment

A first exemplary embodiment of the invention is described. FIG. 1 is a perspective view of a multilayer printed circuit board 1 including a noise suppression device 2A of the first exemplary embodiment of the invention. FIG. 2 is a perspective view of the noise suppression device 2A. FIG. 3A and FIG. 3B are diagrams illustrating configurations of the noise suppression device 2A. FIG. 3A is a top view of the noise suppression device 2A shown in FIG. 2, FIG. 3B is a lateral view, and FIG. 3C is a cross-sectional view along a line A-A in FIG. 3A.

The multilayer printed circuit board 1 is explained by exemplifying a multilayer printed circuit board composed of a plurality of layers. In FIG. 2, FIG. 3A and FIG. 3B, a dielectric material, like glass-epoxy or alumina is not shown, which has insulating properties and forms each layer of the multilayer printed circuit board 1.

In the multilayer printed circuit board 1 shown in FIG. 1, a radio circuit 7A and a digital circuit 7B are exemplified as multilayer printed circuit board mounting components. However the invention is not limited to the above mounting components.

The radio circuit 7A and the digital circuit 7B are connected one another through a linear pattern 4. The linear pattern 4 is linear circuit wiring, like a signal line, a power source line, or a ground line, which is configured to connect the two circuits as described above. The linear pattern 4 has a size (width size and thickness size) corresponding to a design specification of the multilayer printed circuit board 1. In the exemplary embodiment, a noise current which flows on a top face and a bottom face, and a left lateral and a right lateral of the linear pattern 4 is suppressed.

As shown in FIG. 2 and the like, the noise suppression device 2A includes a first resonator unit 10A and a second resonator unit 11A. The first resonator unit 10A in configured by resonance patterns 13 (13a to 13d) and short-circuit patterns 16 (16a, 16b). The second resonator unit 11A is configured by resonance patterns 14 (14a to 14d) and the short-circuit patterns 16 (16a, 16b).

The resonance patterns 13a, 13d, 14a, and 14d are arranged on a right position and a left position relative to the linear pattern 4 (a right position and a left position on a face of the same layer as the linear pattern 4), and the resonance patterns 13b, 13c, 14b, and 14c are arranged on an upper position and a lower position relative to the linear pattern 4 (positions on an upper layer and a lower layer). Thereby, the linear pattern 4 is enclosed by the resonance patterns 13a to 13d, and 14a to 14d, from the right, left, upper, and lower sides. The right, left, upper, and lower sides in this case shows right, left, upper, and lower sides are located when the multilayer printed circuit board 1 is placed on a table.

The short-circuit pattern 16 includes a right-left short-circuit pattern 16a connecting the right and left resonance patterns 13a, 13d, 14a, and 14d to the linear pattern 4, and a upper-lower short-circuit pattern 16b connecting the upper and lower resonance patterns 13b, 13c, 14b, and 14c to the linear pattern 4.

All the resonance patterns 13 and 14 are connected to the linear pattern 4 through the short-circuit pattern 16. The short-circuit pattern 16 is shared by the first resonator unit 10A and the second resonator unit 11A and works as a short-circuited end.

A plated through-hole or a plated via hole is used as the upper-lower short-circuit pattern 16b. Use of the plated through-hole or the plated via hole is selected based on a manufacturing method of the multilayer printed circuit board. A basic configuration is to open a through hole (through-hole or via hole) in the layers of the multilayer printed circuit board, and to plate an inner wall of the through hole to connect wiring formed on the upper and the lower layers.

The resonance patterns 13 and 14 are linear patterns configured at the right, left, upper, and lower sides of the linear pattern 4, and are extended in the right and left directions (right and left directions in FIG. 2) along the linear pattern 4 centering around the short-circuit 16. End parts to which the resonance patterns 13 and 14 are extended forms open ends 17 and 18 which are opened and have high-impedance (refer to FIG. 3A and FIG. 3B). Thereby the first resonator unit 10A and the second resonator unit 11A form a back to back structure in which the short circuit pattern 16 are arranged therebehind and the open ends 17 and 18 face in opposite directions one another.

Resonance lengths of the resonance patterns 13a to 13d are set to L1a to L1d, and resonance lengths of the resonance patterns 14a to 14d are set to L2a to L2d, respectively. Though each of resonance lengths is not necessarily required to be equal, L1a=L1b=L1c=L1d=λ1/4, and L2a=L2b=L2c=L2d=λ2/4 are set in order to simply the explanation. λ1 is a wave length of a frequency (resonance frequency) of the noise targeted for noise suppression in the first resonator unit 10A. λ2 is a wave length of a frequency (resonance frequency) of the noise targeted for noise suppression in the second resonator unit 11A.

If L1a≠L1b≠L1c≠L1d, and L2a≠L2b≠L2c≠L2d, the resonance frequency corresponding to each resonance length is defined and noise currents having respective resonance frequency are suppressed. That is, one resonance pattern (e.g. resonance pattern 13a) and the short circuit pattern 16 (e.g. right-left short-circuit pattern 16a) form a resonator having one resonance frequency.

When a resonator configured by one resonance pattern and a short-circuit pattern is described as a basic resonator, each of the first resonator unit 10A and the second resonator unit 11A is configured by four basic resonators. If resonance frequencies of respective basic resonators are different one another, noises having different basic frequencies can be suppressed. If resonance frequencies of respective basic resonators are set to the same basic frequency, a noise suppression effect can be increased.

FIG. 4A and FIG. 4B are diagrams illustrating equivalent models of the resonator units 10A and 11A in a case that resonance lengths of the resonance patterns are set to the same value, FIG. 4A is the equivalent model of the first resonator unit 10A, and FIG. 4B is the equivalent model of the second resonator unit 11A. Generally, input impedance of the open ends 17 and 18 are high values (ideally infinity). As shown in FIG. 4A, a noise current Id_a flowing from the side of the radio circuit 7A to the side of the first resonator unit 10A becomes difficult to flow to the side of the short-circuit pattern 16 due to the open end 17. Therefore, a noise current Id_a flowing from the side of the radio circuit 7A to the side of the digital circuit 7B can be suppressed.

As shown in FIG. 4B, a noise current Id_b flowing from the side of the digital circuit 7B to the side of the second resonator unit 11A becomes difficult to flow to the side of the short-circuit pattern 16 due to the open end 17. Therefore, a noise current Id_b flowing from the side of the digital circuit 7B to the side of the radio circuit 7A can be suppressed.

The noise current suppression device described above can be formed at the same time as the linear pattern is formed in a manufacturing process of the multilayer printed circuit board. The multilayer printed circuit board is manufactured by various manufacturing method, like a printing technology or a photo lithography technology.

When the photo lithography technology is used, a film of a material (e.g. copper, aluminum) of the linear pattern is formed on a dielectric material layer, and resist is applied thereon. After that, using a mask with a mask pattern corresponding to the linear pattern or the resonance pattern, a latent image of the linear pattern or the resonance pattern is formed on the resist to form a resist pattern. When the material film of the linear pattern is etched by using the resist pattern, as an etching mask, the linear pattern or the resonance pattern is formed. The right-left short-circuit pattern is formed together with the resonance pattern.

After that the upper-lower short-circuit pattern is formed. The upper-lower short-circuit pattern is also formed together therewith in the process of manufacturing interlayer connection in the multilayer printed circuit board.

The noise current suppression device of the exemplary embodiment can be manufactured without changing the manufacturing process of the multilayer printed circuit board and without increasing an operation man-hour.

Since the linear pattern is enclosed in three dimensions from the right, left, upper, lower sides by the resonance patterns, the noise current which flows not only on the top and bottom faces of the linear pattern but on the right and left laterals thereof is suppressed. Therefore a remarkable noise suppression effect can be acquired.

In particular, it is effective for a signal line in which the width size of the linear pattern cannot be sufficiently large compared with the thickness size thereof. As described above, this is caused by the noise current with high frequency which flows close to a surface of the linear pattern. If the width size of the linear pattern is not sufficiently large compared with the thickness size thereof, the noise current which flows on the right lateral and the left lateral of the linear pattern has a large share in a total amount of the noise current flowing in the linear pattern. Therefore, even though only the noise current flowing on the top face and the bottom face of the linear pattern is suppressed, sufficient the noise suppression effect is not acquired.

If only the noise current flowing on the top face and the bottom face of the linear pattern is suppressed, the suppressed noise current flows on the right lateral and the left lateral of the liner pattern.

When the linear pattern is enclosed in three dimensions from the right, left, upper, lower sides, the noise current which flows not only on the top and bottom faces of the linear pattern but on the right lateral and the left lateral thereof can be suppressed. Therefore the remarkable noise suppression effect is acquired.

The resonance patterns can be linearly formed as the linear pattern is. An area occupied by the resonance pattern can be reduced and further an area where the resonance patterns are formed can be easily secured. Thereby high-density mounting can be performed while achieving high noise suppression.

Since the noise suppression device can be configured together with the linear patterns, the need to arrange later an EMC component, like a chip capacitor and to mount it, is widely reduced. Therefore cost-cutting of a manufacturing cost and a component cost can be performed.

Since it is easy to design so that resonance frequencies of respective basic resonators configuring the first resonator unit and the second resonator unit are different one another, a noise of a frequency to be suppressed can be effectively suppressed. Therefore the noise suppression device with high functionality and high quality can be provided.

### Second Exemplary Embodiment

Next a second exemplary embodiment of the invention is explained. The same configuration as the first exemplary embodiment has the same reference numerals as the first exemplary embodiment, and therefore explanation thereon is optionally omitted. In the first exemplary embodiment, each of the first resonator unit 10A and the second resonator unit 11A includes four basic resonators. However, both of the first resonator unit 10A and the second resonator unit 11A may not include the four basic resonators depending on a product, an applied position, or the like.

A case in which mounting components and patterns to get signals through are arranged close to the resonator unit corresponds to the case above mentioned. If high-density mounting cannot be performed when the four basic resonators are arranged, the number of the basic resonators of the first and the second resonator units may be adjusted.

FIG. 5A and FIG. 5B are diagrams illustrating configurations of the noise suppression device 2B of the second exemplary embodiment of the invention. FIG. 5A is a perspective view, FIG. 5B is a top view, and FIG. 5C is a lateral view. As shown in the drawings above, the first resonator unit 10A includes the four basic resonators just like the first exemplary embodiment, and the second resonator unit 11B includes two basic resonators unlike the first exemplary embodiment. The second resonator unit 11B includes two basic resonators, i.e. one basic resonator including the resonance patterns 14a and the short-circuit pattern 16a and the other basic resonator including the resonance patterns 14d and the short-circuit pattern 16a.

The exemplary embodiment is not limited to the configuration shown in FIG. 5A to FIG. 5C, and may include the configuration shown in FIG. 6A to FIG. 6C. FIG. 6A to FIG. 6C are diagrams illustrating a configuration of a noise suppression device 2C, FIG. 6A is a perspective view, FIG. 6B is a top view, and FIG. 6C is a lateral view. In the noise suppression device 2C, each of the first resonator unit 10B and the second resonator unit 11B includes two basic resonators.

The first resonator unit 10B includes two basic resonators, i.e. one basic resonator including the resonance patterns 13b and the short-circuit pattern 16b and the other basic resonator including the resonance patterns 13c and the short-circuit pattern 16b. The second resonator unit 11B includes two basic resonators, i.e. one basic resonator including the resonance patterns 14a and the short-circuit pattern 16a and the other basic resonator including the resonance patterns 14d and the short-circuit pattern 16a.

Since at least processes and members for manufacturing the omitted basic resonator can be reduced, cost-cutting of a manufacturing cost and a component cost becomes possible, and since other members can be formed in a space for the omitted basic resonator, high-density mounting can be promoted.

### Third Exemplary Embodiment

Next a third exemplary embodiment of the invention is explained. The same configuration as the first exemplary embodiment has the same reference numerals as the first exemplary embodiment, and therefore explanation thereon is optionally omitted. In the above exemplary embodiments, each of the first resonator unit and the second resonator unit includes two or four basic resonators. On the other hand, both of the first resonator unit and the second resonator unit of the exemplary embodiment are not limited to such limitation of the basic resonator and a reference frequency thereof is not limited.

FIG. 7A is a perspective view of a noise suppression device 2D of the exemplary embodiment, and FIG. 7B is an exploded perspective view thereof. As shown in the drawings, the noise suppression device 2D includes a first resonator unit 10D and a second resonator unit 11D. The first resonator unit 10D includes 14 resonance patterns (13Ua to 13Ue, 13Ma to 13Me, 13Da to 13De), right-left short-circuit patterns 16 (16U, 16M, 16D), and an upper-lower short-circuit pattern 16b at the right, left, upper, lower sides thereof. The second resonator unit 11D includes 12 resonance patterns (14Ua to 14Ud, 14Ma to 14Md, 14Da to 14Dd), the right-left short-circuit patterns 16 (16U, 16M, 16D), and the upper-lower short-circuit pattern 16b at the right, left, upper, lower sides thereof.

A group of the resonance patterns 13Ub to 13Ud, 13Mb to 13Mc, and 13Db to 13Dd (referred to as first group) are set to the same resonance length, and a group of the resonance patterns 13Ua, 13Ue, 13Ma, 13Md, and 13Da to 13De (referred to as second group) are set to the same resonance length. The resonance length of the first group may be equal to the resonance length of the second group. FIG. 7A and FIG. 7B exemplify a case in which different resonance lengths are set.

If the different resonance lengths are set, noises with different frequencies are suppressed. If the same resonance length is set, remarkable noise suppression effect can be obviously acquired.

FIG. 8A and FIG. 8B illustrate a noise suppression device 2E without the second resonator unit 11D. Whether the second resonator unit 11D is omitted or not is chosen depending on a situation to which the noise suppression device 2E is applied.

If the second resonator unit 11D is omitted, manufacturing is easy. It is unnecessary to secure an area occupied by omitted resonance patterns, and since another configuration can be formed on the vacant area, further high-density mounting is possible.

### Fourth Exemplary Embodiment

Next a fourth exemplary embodiment of the invention is explained. The same configuration as the first exemplary embodiment has the same reference numerals as the first exemplary embodiment, and therefore explanation thereon is optionally omitted. In the above exemplary embodiments, the resonance patterns of the basic resonator are linearly formed along the linear pattern. It is not a necessary requirement of working as a resonator to linearly form the resonance patterns. That is, it is necessary that the resonance length is a predetermined length.

Therefore, the resonance patterns of the basic resonator of the exemplary embodiment include shapes shown in FIG. 9A to FIG. 9E. FIG. 9A to FIG. 9E illustrate the linear pattern 4 and resonance patterns 13 (13e to 13i) with lines on a top view of one resonator unit.

FIG. 9A shows the curved-shaped resonance pattern 13e, FIG. 9B shows the spiral-shaped resonance pattern 13f, FIG. 9C and FIG. 9D show the switchback-shaped resonance patterns 13g, 13h, and FIG. 9E shows the step-like-shaped resonance pattern 13i.

It is obviously possible to arrange the resonance patterns 13e to 13i shown in FIG. 9A to FIG. 9E in the upper-lower, right-left, or oblique directions. It is also possible to arrange a combination of the resonance patterns 13e to 13i which have different shapes in one resonator unit.

When the resonance patterns are formed into a shape other than the linear shape, even though it is difficult to secure a space on which the linear-shaped resonance pattern is formed, the other vacant space can be efficiently used. The multilayer printed circuit board in which further high-density mounting is possible can be provided.

In each exemplary embodiment described above, the basic resonator is configured by using the resonance patterns which are thin wiring, and is arranged so that the linear pattern in which the noise current flows is enclosed. Thereby noise suppression can be efficiently performed and an area occupied by the resonance patterns can be reduced. Since a degree of freedom of resonance pattern arrangement increases, it is easy to choose an area on which the resonance patterns are formed. The noise suppression device and the multilayer printed circuit board can be manufactured at a low price based on these effects.

Since the noise suppression device can be easily configured in the substrate of the multilayer printed circuit board, the need to mount EMC component, like a chip capacitor, is reduced. Therefore, from this viewpoint, the noise suppression device and the multilayer printed circuit board can be manufactured at a low price.

Though being described based on the above exemplary embodiment (and example), the inventions are not limited to the above exemplary embodiment (and example). It is to be understood that to the configurations and details of the invention of the present application, various changes can be made within the scope of the invention of the present application by those skilled in the art.

This application claims priority from Japanese Patent Application No. 2011-138668 filed on Jun. 22, 2011, the contents of which are incorporation herein by reference in their entirety.

### EXPLANATION OF REFERENCE NUMERALS

1 multilayer printed circuit board
2A-2E noise suppression device
4 linear pattern
10A, 10B, 10D first resonator unit
11A, 11B, 11D second resonator unit
13Ua-13Ue, 13Ma-13Md, 13Da-13De resonance pattern
14Ua-14Ud, 14Ma-14Md, 14Da-14Dd resonance pattern
14a-14d resonance pattern
16 short-circuit pattern
16a right-left short-circuit pattern
16b upper-lower short-circuit pattern
17, 18 open end

1-9. (canceled)

10. A noise suppression device for suppressing a noise current flowing in a linear pattern arranged in a substrate of a multilayer printed circuit board, comprising:
a resonator unit having a plurality of basic resonators each of which is comprised of a resonance pattern with a prescribed resonance length and a short-circuit pattern for connecting one end of the resonance pattern to the linear pattern, wherein
the resonator unit includes the basic resonator having the resonance pattern provided on either one or both of an upper position and a lower position relative to the linear pattern and the basic resonator having the resonance pattern provided on either one or both of a left position and a right position relative to the linear pattern.

11. The noise suppression device of claim 10, wherein
the two or more resonator units are arranged, at least the two resonator units of which share each of the short-circuit patterns and are arranged such that directions of open ends of the resonator units are oppositely arranged one another around the short-circuit pattern.

12. The noise suppression device of claim 11, wherein
the resonator unit includes a plurality of pairs of the reference resonators, the pair of the resonators including the reference resonator with the linear pattern arranged on the upper position relative to the linear pattern and the reference resonator with the linear pattern arranged on the lower position relative thereto.

13. The noise suppression device of claim 12, wherein
the resonator unit includes a plurality of pairs of the reference resonators, the pair of the resonators including the reference resonator with the linear pattern arranged on the right position relative to the linear pattern and the reference resonator with the linear pattern arranged on the left position.

14. The noise suppression device of claim 13, wherein
the resonator unit includes a plurality of pairs of the reference resonators, the pair of the resonators including the reference resonator with the linear pattern arranged on the right position relative to the linear pattern and the reference resonator with the linear pattern arranged on the left position.

15. The noise suppression device of claim 10, wherein
the resonance length of the resonance pattern is determined on the basis of a frequency of the noise current to be suppressed.

16. The noise suppression device of claim 15, wherein
the resonance lengths of all the resonance patterns included in the resonator unit is set in the same size.

17. The noise suppression device of claim 10, wherein
a shape of the resonance pattern includes any one shape of a line, a curve shape, a spiral shape, a switchback shape, and a step-like shape.

18. A multilayer printed circuit board that is configured by a plurality of layers, comprising:
a linear pattern that is configured in at least one interlayer; and
the noise suppression device of claim 10, wherein
the noise suppression device includes a resonator unit having a plurality of basic resonators each of which is comprised of a resonance pattern with a prescribed resonance length and a short-circuit pattern for connecting one end of the resonance pattern to the linear pattern, wherein the resonator unit includes the basic resonator having the resonance pattern provided on either one or both of an upper position and a lower position relative to the linear pattern and the basic resonator having the resonance pattern provided on either one or both of a left position and a right position relative to the linear pattern.
